(19) United States
(12) Patent Application Publication
(10) Pub. No.: US 2009/0035095 A1
(43) Pub. Date: Feb. 5, 2009

(54) Bookbinding Unit and Image-Forming System Equipped with the Same

(75) Inventors: Tadahito Takano, Fuefuki-shi (JP); Atsushi Tsuchiya, Minami-Alps-shi (JP); Kazuyuki Kubota, Minamikoma-gun (JP); Kouichi Kitta, Koshu-shi (JP); Akihiko Tsukui, Kai-shi (JP); Hideki Aoyagi, Nakakoma-gun (JP); Suguru Maruyama, Minamikoma-gun (JP)

Correspondence Address: Judge Patent Associates, Dojima Building, 5th Floor, 6-8 Nishitemma 2-Chome, Kita-ku, Osaka-Shi, 530-0047, JP

(73) Assignee: NISCA CORPORATION, Yamanashi-ken (JP)

(21) Appl. No.: 12/180,518

(22) Filed: Jul. 26, 2008

(30) Foreign Application Priority Data
Aug. 1, 2007 (JP) 2007-200509

(51) Int. Cl. B42C 9/00

(52) U.S. Cl. 412/37

(57) ABSTRACT

Bookbinding unit to avert sheets coming loose and other problems that, due to adhesive leakage in coating an adhesive onto a sheaf and pasting on a cover sheet, lead to poor binding. Provided with unit housing, sheaf retainer for retaining in an adhesive-application position sheets collated into book blocks, adhesive container for storing hot-melt adhesive, heater built-in to the adhesive container for melting the adhesive at a predetermined temperature, temperature controller for controlling the heater, applicator for applying adhesive to sheaves, and cover binder disposed downstream of the adhesive-application location for binding sheaves coated with adhesive together with cover sheets. The controller has a first sensor for detecting the adhesive temperature the adhesive container, and a second sensor for detecting ambient temperature inside the unit housing, and controls the heating temperature of the heater according to the temperatures detected by the first and second sensors.

### BACKGROUND OF THE INVENTION

1. Technical Field

The present invention—involving bookbinding units and image-forming systems that collate and compile sheets conveyed out of an imaging device or similar machine, coat the spine-portion edge of the sheets with adhesive, and bind the sheets together with a cover sheet—relates to improvements in temperature control in the melting of hot-melt adhesive at a predetermined temperature.

2. Description of the Related Art

In general, bookbinding units of this sort are known broadly as terminal devices for digital printers, printing machines, or other imaging apparatus, and as devices that stack in page order sheets onto which images have been formed (“printed sheets” hereinafter), collate the sheets into a bundle, and finish the bundle into a booklet by applying adhesive to its saddle-stitched edge-face and binding the bundle together with a cover sheet. Employed therein for the unit that applies the adhesive are an adhesive container for storing adhesive, and a structural makeup for melting the solid adhesive with a built-in heating means in the container and for applying the liquefied adhesive to one edge of a sheet bundle with an applicator roller.

Thus, the system (hot-melt adhesive) whereby the container is provisioned with a solid adhesive and then the adhesive is thermally dissolved features ease of adhesive handling, but special care must be taken to govern the post-melting temperature in the adhesive container. For example, the melting point for routinely employed solid adhesives is some 60° C. to 80° C., while in applying the adhesive to sheets or other articles to be glued, the adhesive must be kept at optimum temperature, such as 140° C. to 150° C. This is because secure adhesion requires that the adhesive penetrates between and bonds the leaves of booklet sheets.

In this case, if the temperature of the adhesive is higher than the optimum temperature, the adhesiveness will be weak (it will have low viscosity), leading to the troublesome situation of the adhesive dripping or splattering and soiling the cover sheets, etc. in the course of the adhesive being applied to sheet bundles. Also, if the temperature of the adhesive is lower than the optimum temperature, secure adhesion will not be attained, causing sheets to come loose or giving rise to similar problems. Along with these problems, the melting conditions (time) for a hot-melt adhesive differ between when the amount charged into the adhesive container is large-volume and when it is small-volume. Furthermore, the adhesive in the container hardens when the unit is not in use and the hardened states differ depending on the ambient temperature, yet hardened or freshly injected adhesive must be melted swiftly and retained at a predetermined temperature when the bookbinding unit or similar device is started up.

Proposals to date for this sort of temperature control of solid adhesive include, in Japanese Unexamined Pat. Pub. App. No. 2005-238526, the provision of a heat-retaining mode for when the unit is not in use. This publication discloses a heat-retaining mode that maintains the adhesive container for an adhesive paste at a temperature lower than the application temperature in situations where a standby state in the bookbinding unit, in which the adhesive paste has not been coated onto a sheet bundle, has persisted.

Furthermore, Japanese Unexamined Pat. Pub. App. No. 2003-010748 discloses a heating method in which an electromagnetic induction coil is furnished in the adhesive container to melt an adhesive paste inside with the Joule heat from eddy currents stemming from high-frequency magnetic flux applied to the coil. The current supplied to the coil is adjusted according to the paste temperature detected by a sensor (thermistor) provided in the adhesive container.

As discussed above, in bookbinding unit and similar devices methods have been adopted to detect the temperature of the adhesive in the container using a sensor and then raise the temperature of the adhesive to an optimum, predetermined degree when adhesive is being applied to a sheet bundle. In this case, if the adhesive temperature is too high when adhesive is being applied to a sheet bundle, the adhesive can drip or splatter, soiling cover sheets, etc. The adhesive can also stick to places other than the spine portion, leading to poor-quality book-forming. Also, conversely, if the adhesive temperature is too low, the adhesive applied to the saddle-stitched edge-face will fail to penetrate between the individual leaves of sheets. An insufficient amount of adhesive between the sheets causes poor binding and leads to sheet inner leaves coming loose and falling out of the bound booklet.

Conventionally, the adhesive temperature in the container has been associated with poor binding, so an attempt has been made to control the adhesive temperature to the optimum level. However, the overall temperatures of the sheet bundle and cover sheet also affect the quality of the binding. The ambient temperature when the adhesive is being applied, and the ambient temperature when an adhesive-coated sheet bundle is being bound into a cover sheet also affect the quality of the binding.

For example, if the temperature of the sheet bundle is low, the adhesive will not adequately penetrate the inner leaves of a sheet bundle. In such a case, sheets that have not been adequately glued may fall out of the booklet later. If the cover sheet temperature is too low, the adhesive can harden prematurely. Wrinkles and other deformities such as unevenness can result when the cover sheet is folded to encase the sheet bundle. Also, if the sheet bundle temperature is too high, an excess amount of adhesive can penetrate between the inner leaves of the sheet bundle, again degrading the quality of the final binding. If the cover sheet temperature is too high, adhesive can leak out when the cover sheet is folded over the sheet bundle to form the booklet.

However, the ambient temperatures when coating the edges of the sheet bundle with adhesive, and when binding the sheet bundle to the cover sheet also affect the quality of the binding. For example, if the ambient temperature is too high when the adhesive is being applied to the cover sheet, the adhesive can drip or splash. Conversely, if that temperature is too low, the surface of the adhesive layer can harden, causing a film to develop over the layer, which prevents the adhesive from properly getting between the inner leaves of the sheet bundle. Also, if the ambient temperature is too high when affixing a cover sheet to a sheet bundle, adhesive can leak. If the ambient temperature is too low, the spine portion of the cover sheet can be wrinkled or otherwise defaced when it is folded.

### BRIEF SUMMARY OF THE INVENTION

Therein, inventors arrived at the concept of detecting the influence of the sheet-leaf temperature of a (saddle-stitched) sheaf, and the ambient temperature during adhesive application, as well as the sheet-leaf temperature of the cover, and the ambient temperature when cover is being pasted on—detecting the device-internal ambient temperature—to control the temperature of the adhesive inside the container.

An object of the present invention is to provide a bookbinding unit that does not cause a problem such as sheets falling out of the bound sheet bundle and at the same time cause a poor binding because of adhesive leakage, when coating the sheet bundle with adhesive and binding that to the cover sheet.

Another object of the present invention is to provide a bookbinding unit that can control the temperature of the adhesive in the container with a simple structure to conditions appropriate for the temperature of the inner leaves of the sheet bundle, the temperature of the cover sheet, and the ambient temperature of the bookbinding process.

The present invention employs the following configuration to solve the aforementioned problems. Unit housing, sheet bundle holding means for holding the sheets collated into a sheet bundle at an adhesive-application location, an adhesive container that stores hot-melt adhesive, heating means built-in to the adhesive container for melting the adhesive at a predetermined temperature, temperature control means for controlling the heating means, applicator means for applying adhesive to the sheet bundle, and cover sheet binding means disposed downstream of the adhesive-application location for binding the sheet bundle coated with adhesive to the cover sheet are provided. The control means has a first sensor means for detecting the temperature of the adhesive in the adhesive container, and a second sensor means for detecting the ambient temperature inside the unit housing. The control means controls the heating temperature of the heating means according to the temperatures detected by the first and second sensor means.

The temperature control means raises the temperature of the adhesive to a predetermined degree when the temperature detected by the second sensor means is higher than a predetermined degree. The temperature control means raises the temperature of the adhesive to a predetermined degree when the temperature detected by the second sensor means is lower than a predetermined degree.

The second sensor means is disposed near the cover sheet binding position either to detect the ambient temperature of the sheet bundle bound to the cover sheet, or the sensor means is disposed near the adhesive-application location to detect the ambient temperature of the sheet bundle coated with adhesive.

When the second sensor means is disposed near the adhesive-application location, the adhesive container is configured to reciprocate along the edge of the sheet bundle held at the adhesive-application location. Also, the second sensor means is disposed either outside the range of movement of the adhesive container, or it is disposed to detect the temperature inside the unit when the adhesive container is positioned away.

An image-forming unit that has image-forming means for sequentially forming images on sheets, and a bookbinding unit that collates into sheet bundles sheets conveyed from the image-forming unit, coats an edge of the sheet bundle with adhesive and binds the sheet bundle to a cover sheet are provided. The bookbinding unit has a stacking means for collating into sheet bundles sheets conveyed from the image-forming means, and has the configuration described above.

The present invention is equipped with temperature control means for controlling the temperature of the adhesive in the container, the first sensor means for detecting the temperature of the adhesive in the container, and the second sensor means for detecting the ambient temperature in the unit housing, the control means controls the heating means of the adhesive container according to the temperatures detected by the first and second sensor means. These have the following effects.

The ambient temperature in the unit housing is detected, so when the ambient temperature is lower than a predetermined degree, the adhesive temperature in the container is raised to a predetermined degree. Therefore, when the temperature of the inner leaves of the sheet bundle and the ambient temperature for coating the sheet bundle with adhesive are low, the adhesive temperature is raised so the problem of sheets coming loose and falling out of the bound booklet does not occur because adhesive can adequately permeate between the leaves of sheets. Similarly, if the cover sheet at the cover sheet binding position is low temperature, even if the ambient temperature is low when binding the cover sheet, the adhesive temperature is raised so the adhesive does not prematurely harden which can cause wrinkles or other deformations of the cover sheet.

Furthermore, if the second sensor means that detects the ambient temperature in the unit housing is disposed to detect the ambient temperature of the bound sheet bundle, it is possible to control the adhesive temperature so that it is at the proper temperature when the cover sheet is bound to encase the sheet bundle and when the cover sheet is folded to encase the sheet bundle. Therefore, wrinkles or other unevenness do not occur in the spine portion of the cover sheet if the adhesive temperature is low when the cover sheet is being folded. Also, adhesive does not leak out of the binding when folding the cover sheet if the adhesive temperature is high.

By disposing the second sensor means that detects the ambient temperature in the unit housing near the adhesive-application location, it is possible to control the temperature so that surface of the adhesive layer will not harden and form a film when the adhesive is being applied to the edge of the sheet bundle. Therefore, the adhesive layer on the sheet bundle edge will not harden and be prevented from penetrating between the inner leaves of the sheet bundle.

### BRIEF DESCRIPTION OF THE SEVERAL VIEWS OF THE DRAWINGS

FIGS. 1A to 1C are explanatory views of an adhesive application unit used in a bookbinding unit according to the present invention; FIG. 1A is a perspective view of the external shape of the unit; FIG. 1B is a sectional view in an X-X direction; FIG. 1C is a sectional view in a Y-Y direction;

FIG. 2 is an overall view of an image-forming system installed with the adhesive application unit;

FIG. 3 is an explanatory view showing in detail the bookbinding unit in the system shown in FIG. 2;

FIG. 4 is a structural chart of an adhesive application operation in the adhesive container shown FIG. 1;

FIGS. 5A and 5B are explanatory views of a bookbinding operation in the system shown in FIG. 3; 5A shows a state of adhesive being applied to a spine of a sheet bundle; 5B shows a state where the sheet bundle being joined to a cover sheet;

FIGS. 6C and 6D are explanatory views of the bookbinding operation in the system shown in FIG. 3; 6C shows an initial state of the sheet bundle and cover sheet being bound; 6D shows a state where the cover sheet is being folded over and covering the sheet bundle; and

FIG. 7 is a block diagram of a configuration of a temperature control means for the adhesive in the unit shown in FIG. 3.

### DETAILED DESCRIPTION OF THE INVENTION

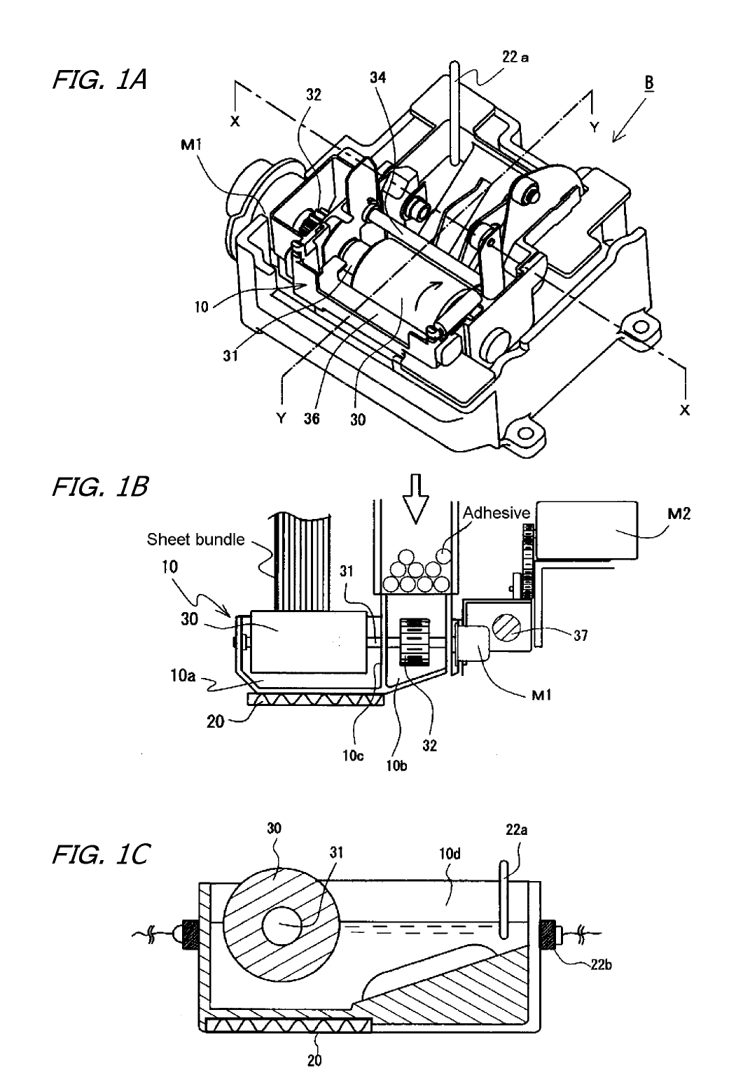

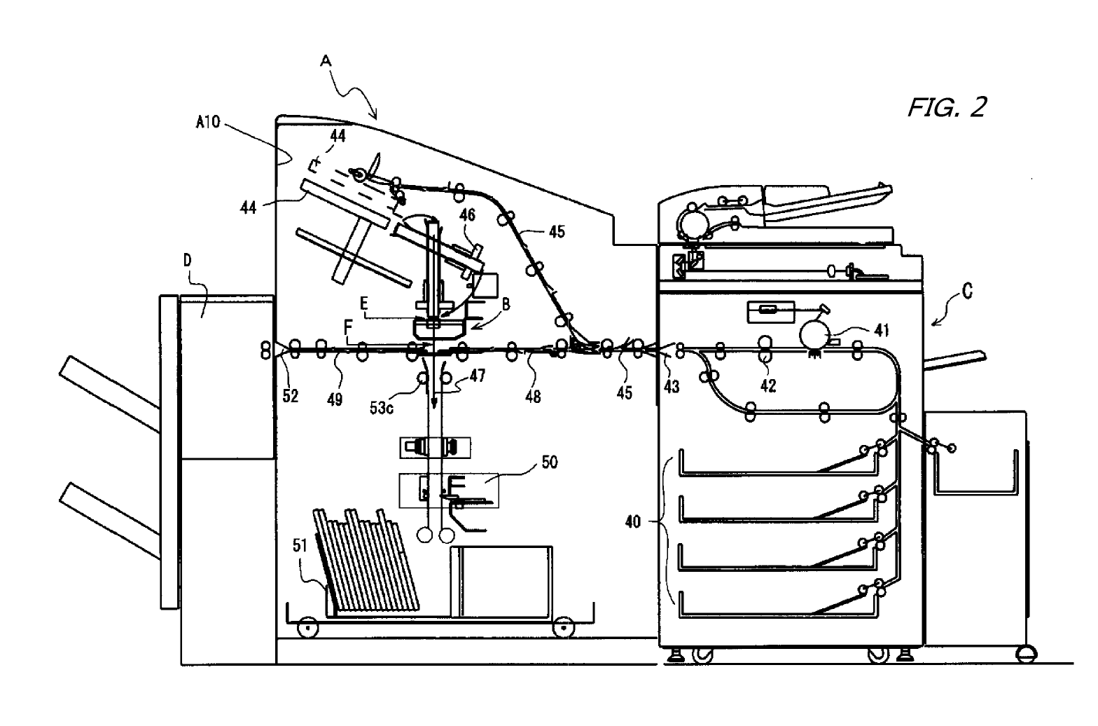

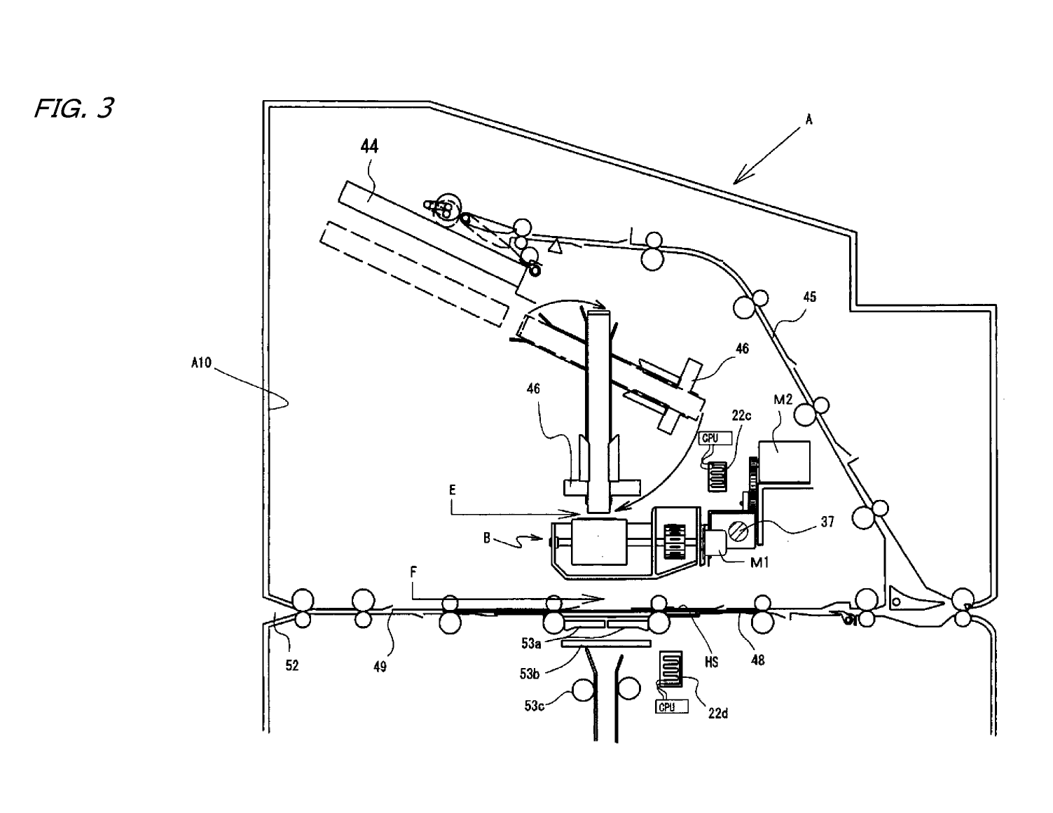

A preferred embodiment of the present invention will now be explained based on the drawings provided. An adhesive application unit B built-in to the bookbinding unit of the present invention will now be explained with reference to FIGS. 1 to 4. FIG. 1 is an explanatory drawing showing a structure of the adhesive container that stores solid adhesive. FIG. 1A is a perspective view; 1(b) is an X-X sectional view; 1(c) is a Y-Y sectional view. FIG. 2 is an overall view of bookbinding unit with a built-in adhesive application unit and an image-forming system. FIG. 3 is a view of the essential portion of the bookbinding unit shown in FIG. 2.

### Adhesive Application Unit Configuration

The adhesive application unit B shown in FIG. 1A is composed of an adhesive container 10 that stores adhesive; an applicator roller 30 that applies liquefied adhesive to a sheet bundle; and heating means 20 mounted inside the container to melt adhesive. The adhesive container 10 is partitioned into a solid adhesive charging compartment 10b (hereinafter referred to as the charging compartment) and a liquefied adhesive tub 10a (hereinafter referred to as adhesive tub) by a partition 10c; a connecting opening is provided in the partition 10c to allow the adhesive liquefied at the charging compartment 10b to flow into the adhesive tub 10a. This adhesive container 10 is composed of a tub-shaped tray comprising the charging compartment 10b and adhesive tub 10a and either formed from a material with high thermal-conductivity properties such as metal and the like, or a material with high workability properties such as resin and the like. A thermally conductive plate such as metal and the like is laid down at the bottom surface.

The applicator roller 30 is rotatably supported in the adhesive tub 10a. The applicator roller 30 is formed by a heat-resistant rubber material that has a superior impregnating property. The upper half of the applicator roller 30 projects upward from the adhesive tub 10a, and the lower half is disposed to be submerged in the liquefied adhesive in the adhesive tub 10a. Therefore, liquefied adhesive impregnates the applicator roller 30 at the lower half of the roller by the applicator roller 30 being rotated. The upper half, projecting upward, applies the liquefied adhesive to the sheet bundle. A rotating shaft 31 of the applicator roller 30 is arranged longitudinally to the charging compartment 10b via the connecting opening, and a stirring gear 32 that stirs the adhesive in the charging compartment 10b is mounted to this rotating shaft 31.

A forward and reverse-rotating stirring motor M1 is connected to the rotating shaft 31. Therefore, the applicator roller 30 and stirring gear 32 are rotated by rotatingly driving the stirring motor M1. The applicator roller 30 stirs the adhesive in the adhesive container 10, and the stirring gear 32 stirs the adhesive in the charging compartment 10b. 10d in the drawing denotes a liquid adhesive holding portion disposed in the adhesive container 10. This forms a basin for supplying adhesive to the applicator roller 30 at a stable temperature so there is always an adequate amount of adhesive.

An adhesive temperature sensor 22a (first sensor means) is disposed in the liquid adhesive holding portion 10d to detect the temperature of the liquefied adhesive. The adhesive temperature sensor 22a is composed of a rod-shaped thermistor and is disposed in the liquid adhesive holding portion 10d separated from the applicator roller 30. This thermistor is composed of sintered fine-ceramic semiconductor heat-sensitive elements that use a variety of transition metal oxide materials such as Mn, Co, Ni, Fe, Cu and the like as the raw material.

The adhesive temperature sensor 22a in the drawing detects the surface of the adhesive (the remaining amount of adhesive) at the same time as detecting the temperature. In other words, this determines the amount of adhesive using the change in temperature of the surface of the adhesive constantly heated to a temperature higher than room temperature to detect the remaining amount of adhesive. In such a case, the adhesive temperature sensor 22a is disposed in the liquid adhesive holding portion 10d separated from the applicator roller 30 so that the detection of the surface of the adhesive by the adhesive temperature sensor 22a is unaffected by the rotation of the applicator roller 30.

Also, 34 denotes a control rod. This is disposed along an outer circumference of the applicator roller 30 in a lateral direction of the adhesive container 10. This rod is attached at a predetermined distance from the outer surface of the applicator roller 30 to produce a uniform layer of adhesive around the roller surface. The distance of the control rod 34 to the surface of the applicator roller is adjusted according to the position of the sheet bundle. Reference numeral 36 denotes a plate-shaped blade. This is disposed a predetermined distance (doctor gap) from the outer circumference of the applicator roller 30 to sweep away excessive adhesive adhering to the outer circumference of the roller.

Heating means 20 is installed in the adhesive container 10 that is configured as described above. The heating means 20 is composed of an electrically powered heater and is embedded in the floor surface of the adhesive tub 10a of the adhesive container 10. It is acceptable for this electrically powered heater 20 (hereinafter referred to as heating means) to be disposed in at least one of either the adhesive tub 10a or the charging compartment 10b, or in both. Also, it is acceptable to dispose the electrically powered heater in the charging compartment 10b to preheat the solid adhesive.

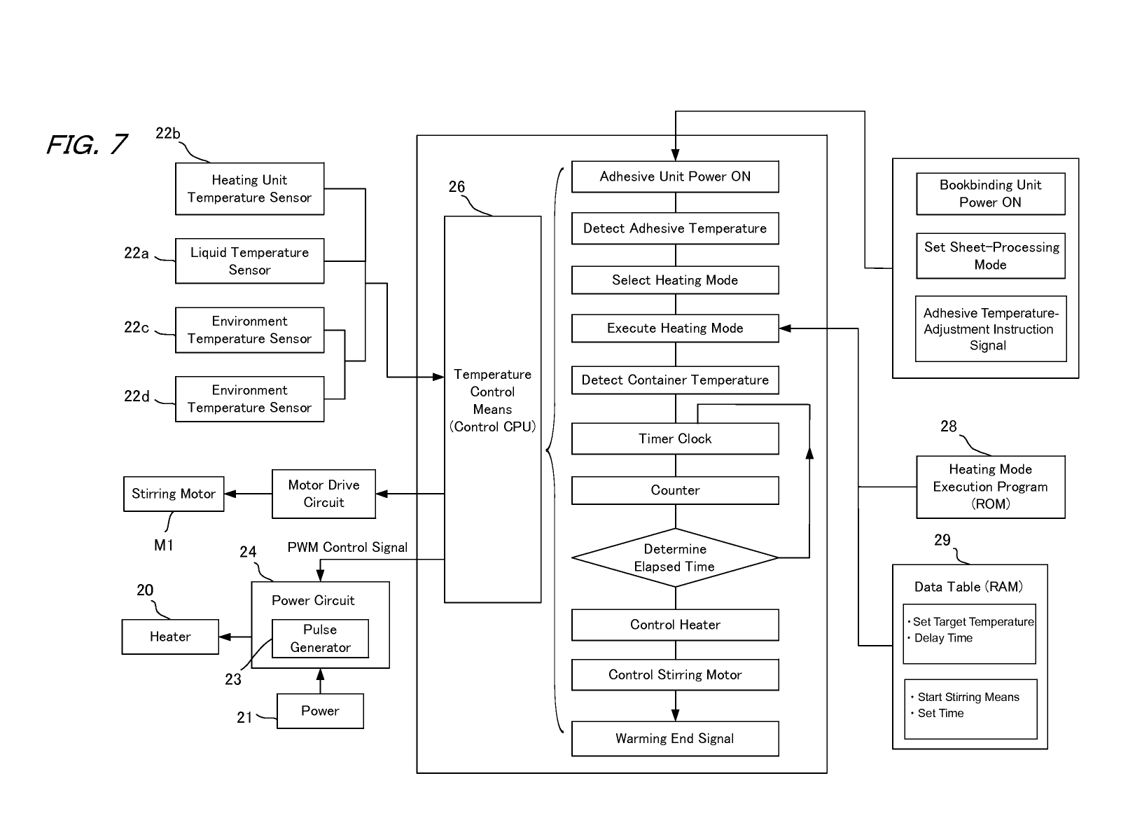

The following will now explain heating temperature control of the heating means 20 (electrically powered heater) disposed in the adhesive tub 10a. The adhesive temperature sensor 22a (first sensor means) is disposed in the adhesive container 10 to detect the temperature of the adhesive liquefied in the adhesive tub 10a. Also, a heating unit temperature sensor 22b that detects the temperature outside of the container heated by the heating means 20 and an erroneous temperature detection sensor, not shown, are disposed in the adhesive container 10. The heating unit temperature sensor 22b detects the temperature of the heating means, and controls the adhesive melting temperature along with the adhesive temperature sensor 22a (first sensor means). The erroneous temperature detection sensor is disposed in the adhesive container 10 for example and detects when the adhesive and the adhesive container 10 containing the adhesive have been over heated and executes a safety measure such as turning off the power to the device. For that reason, these sensors are connected to a control CPU 26 (see FIG. 7).

### Temperature Control Means Configuration

The control CPU 26 shown in FIG. 7 is provided as control means of the bookbinding unit A. This control CPU 26 calls up a heating control execution program 28 (ROM) to control the voltage (or current) supplied to the heating means 20. This composes temperature control heating means that adjusts the temperature of the adhesive in the adhesive container 10. Data for executing the heating operation (such as a target temperature that sets the charged current value, charging time, timer setting and the like) are provided in a data table 29 (RAM). A power supply 21 (DC power in the drawing) and pulse generator 23 are connected to the electrically powered heater (heating means) 20 disposed in the adhesive container 10; the pulse generator 23 composed of the control CPU 26. In other words, pulse currents that correspond to the command signals emitted from the temperature control means (control CPU) 26 are supplied to the electrically powered heater 20. A power supply circuit 24 provided the pulse generator 23 is composed of a PWM (pulse width modulation) circuit and is configured to vary the voltage by changing the pulse width of the power supply using command signals from the control CPU 26.

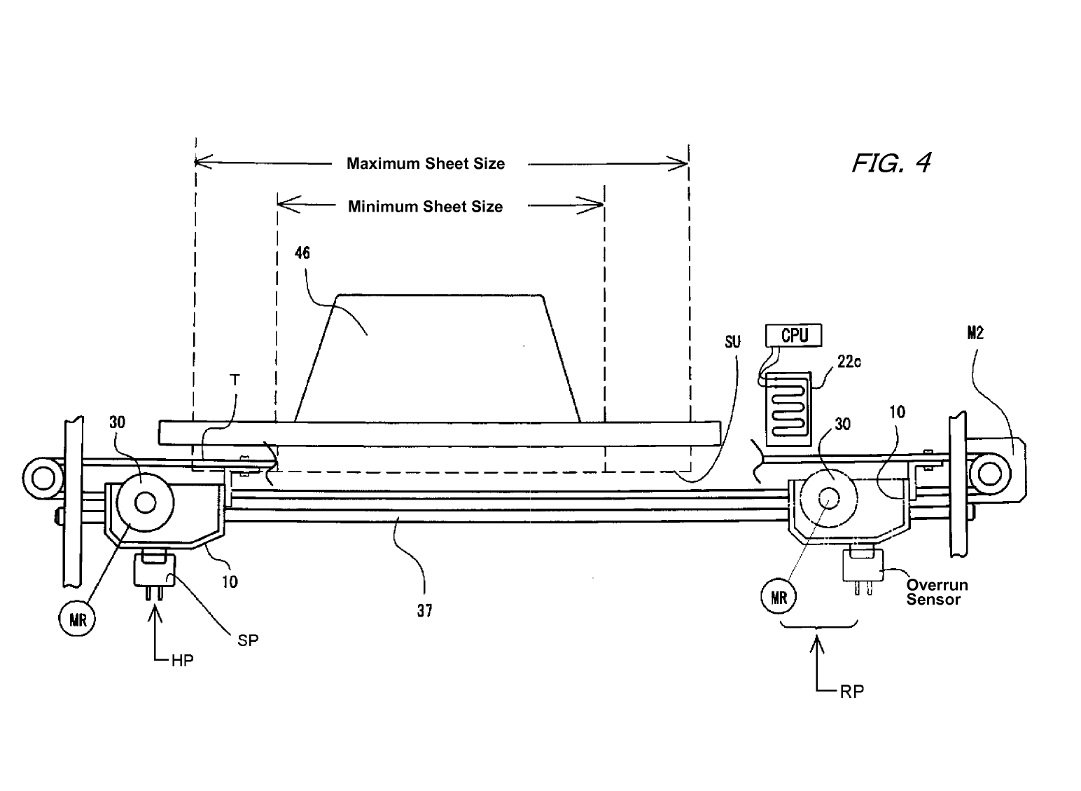

The adhesive container 10 as described above has a reciprocating motion along the sheet bundle. FIG. 4 is a conceptual diagram of the container. The adhesive container 10 is formed to a shorter length (dimension) than the bottom edge of the sheet bundle (the backside covered at the binding process) SU. The container is supported on a guide rail 37 of the apparatus frame to move along the bottom edge SU of the sheet bundle along with the applicator roller 30 installed in that container. The adhesive container 10 is connected to a timing belt T installed on the apparatus frame; a drive motor M2 is connected to the timing belt T.

Therefore, drive motor M2 reciprocates the adhesive container 10 between a home position HP and a return position RP where the return operation is started along the sheet bundle. Each position is set to the positional relationships shown in FIG. 4; the return position RP is set based on sheet width size information. The adhesive container 10 is set to the home position HP when the power is turned on (at device initialization). For example, this moves from the home position HP to the return position RP after a predetermined amount of time after a sheet grip signal from the grip sensor Sg of the gripping conveyance means 46. At the same time as this movement, the stirring motor M1 starts rotating the applicator roller 30. Note that the home position sensor of the adhesive container 10 is given the symbol SP in the drawing. With the adhesive applicator unit B configured as described above, rotation of the drive motor M2 starts moving the adhesive container 10 from the left side of FIG. 4 to the right side along the guide rail 37. The amount of travel of the gripping conveyance means 46 is adjusted by the elevator motor (not shown) so that the applicator roller 30 pressingly contacts the sheet bundle to slightly separate the edges of the sheets in the advancing path, and forms a predetermined gap with the sheet bundle edge in the return path to return from the return position RP to the home position HP to apply adhesive.

### Image-Forming System Configuration

The image-forming system shown in FIG. 2 is composed of a printing unit C and the bookbinding unit A that binds into a booklet printed sheets conveyed from the printing unit C. A stacker D that stores unbound printed sheets is installed next to the bookbinding unit A. This printing unit C is composed of a known structure such as a printer or photocopier and the like. A predetermined sheet is kicked out of a cassette in a feeder unit 40 and is printed by a printing drum 41. After the image is fused to the sheet by a fuser 42, the sheet is then conveyed out from a discharge outlet 43. The printing drum 41 in the drawing is a photoreceptor drum. This uses a static electric printing method that forms a static electric latent image on the surface of the drum using a laser oscillator and transfers that image to the sheet. Other printing methods such as a silk screen printing method, ink-jet printing method can be adopted.

Printed sheets sequentially output from the discharge outlet 43 are collated into a predetermined number of sheets and aligned at the stacking tray 44 in the bookbinding unit A. The symbol 45 in the drawing denotes a sheet conveyance-in path that guides the printed sheets from the discharge outlet 43 to the stacking tray 44. Sheets collated and aligned on the stacking tray 44 are conveyed to the adhesive-application location E by gripping conveyance means 46. Of particular note, the stacking tray 44 is disposed to be in a substantially lateral orientation; the bookbinding path 47 that conveys the sheet bundle using the gripping conveyance means 46 is disposed to be substantially longitudinal. The gripping conveyance means 46 is composed of a pair of gripping means that nip the sheet bundle at its front and back sides and change the orientation of the sheet bundle from a lateral state to a longitudinal state and convey the sheet bundle in a longitudinal direction along the bookbinding path 47.

Also, a cover sheet conveyance path 48 that conveys a cover sheet is connected to a sheet conveyance-in path 45; a sheet conveyance-out path 49 is connected to the cover sheet conveyance path 48. In other words, a printed sheet conveyed from the discharge outlet 43 of the printing unit C is conveyed from the sheet conveyance-in path 45 to the stacking tray 44, and a cover sheet conveyed from the discharge outlet 43 is supplied to the cover sheet conveyance path 48 that branches from the sheet conveyance-in path 45. Also, printed sheets that do undergo the binding operation are conveyed from the discharge outlet 43 through the sheet conveyance-in path 45, cover sheet conveyance path 48 and into the stacker unit D from the sheet conveyance-out path 49, traversing the bookbinding unit A.

The bookbinding path 47 and cover sheet conveyance path 48 are disposed to mutually intersect each other. The sheet bundle conveyed from the bookbinding path 47 and the cover sheet conveyed from the cover sheet conveyance path 48 are joined at the cover sheet binding position F (see FIG. 3). In other words, the cover sheet HS is conveyed to the cover sheet binding position F so that its center line is aligned to the intersecting point and the sheet bundle is touched to the cover sheet in an upside-down T-shape from the bookbinding path 47 that is perpendicular to the sheet bundle. Folding rollers 53c disposed in the bookbinding path 47 downstream of the cover sheet binding position F fold the cover sheet to encase the sheet bundle. The adhesive application unit B is built-in upstream of the cover sheet binding position F.

The sheet bundle sandwiched by the gripping conveyance means 46 and held in an upright orientation at the adhesive-application location E so that its bottom edge is coated with predetermined amount of adhesive. The adhesive container 10 explained with references to FIGS. 1 to 4 in the adhesive application unit B is capable of moving along the bottom edge SU of the sheet bundle. The adhesive container 10 provided the heating means 20 has the same configuration as was described above. Therefore, an explanation thereof will be omitted.

### Explanation of Bookbinding Operation

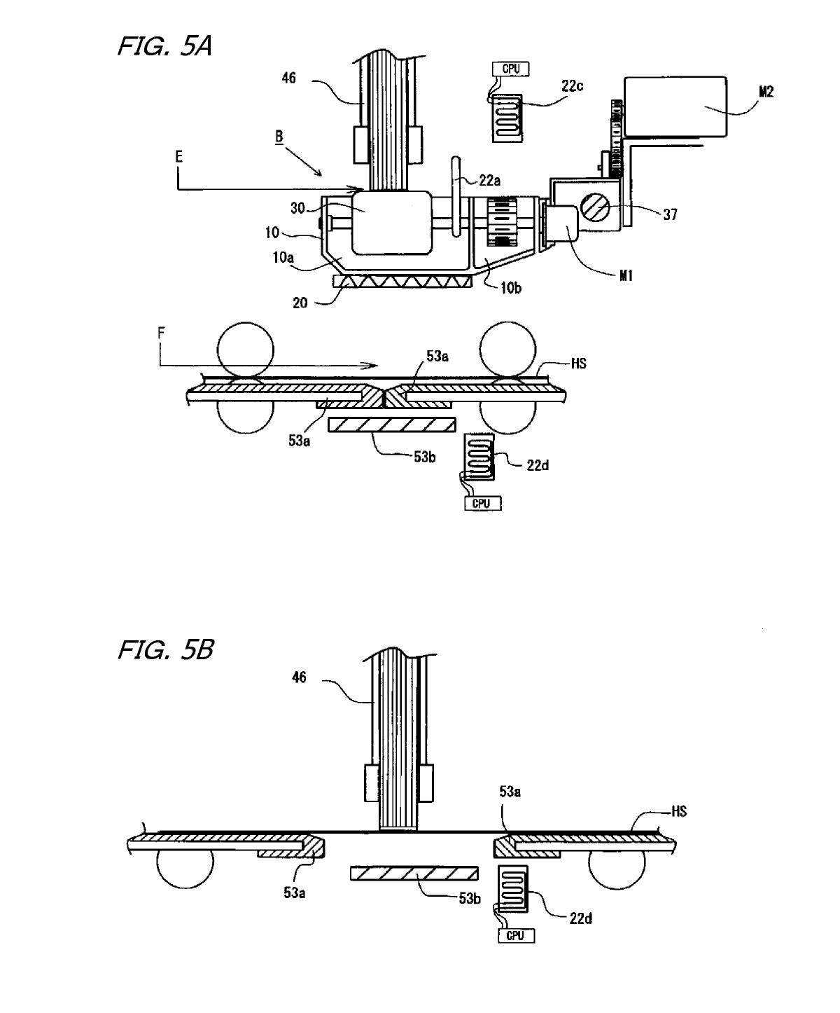

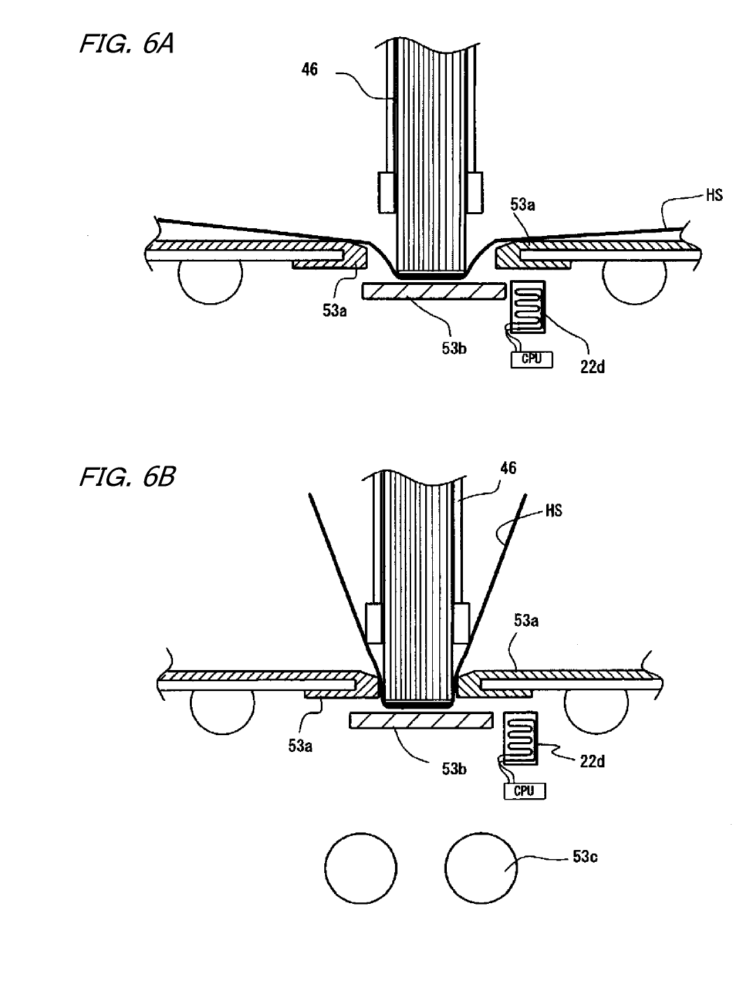

The bookbinding unit A configured as described above and bookbinding operations will now be explained with references to FIGS. 5 and 6. As shown in FIG. 5A, the adhesive container 10 is supported on the guide rail 37 and driven by the drive motor M2 to move along a longitudinal direction of the sheet bundle held by the gripping conveyance means 46.

The adhesive container 10 can move in the longitudinal direction along the spine portion of the sheet bundle (a direction orthogonal to the bundle thickness) and the applicator roller 30 built-in to the adhesive container 10 is rotated in a predetermined direction, for example in a direction reverse to the adhesive container 10 direction of movement. Adhesive on the applicator roller 30 is applied to the spine portion of the sheet bundle (see the state shown in FIG. 5A). Next, after the coating process, the adhesive container 10 is retreated to its outside home position HP from the conveyance path of the sheet bundle in the state shown in FIG. 5B. The second sensor means 22c, described below, detects the ambient temperature of the adhesive-application location E when the adhesive container 10 is at its home position HP.

The sheet bundle coated with adhesive is conveyed to the cover sheet binding position F by the gripping conveyance means 46 and is joined to the cover sheet HS fed from the cover sheet conveyance path 48. (See the state shown in FIG. 6C.) After these are joined, spine folding pressing means 53a disposed in the cover sheet binding position F fold the cover sheet. (See the state shown in FIG. 6D.) Then, the sheet bundle is bound into a booklet by the folding rollers 53c, and when necessary, a trimming unit 50 downstream of the folding rollers 53c trims true edges of the bound sheet bundle. Note that 53b denotes a spine pressing plate disposed in the cover sheet binding position F. This is configured to project into and retreat from the bookbinding path 47. Then, the sheet bundle bound with a cover sheet is stored in a storage stacker 51.

Note that in the foregoing embodiment, an explanation was provided for the cover sheet HS to be conveyed in the same way as a printed sheet from the discharge outlet 43 after it has been printed with a title and the like at the printing unit C, but it is also acceptable to install an inserter between the printing unit and bookbinding unit A to supply the cover sheet HS from the inserter to the sheet conveyance-in path 45. The inserter can be composed of one or a plurality of trays, a separating roller to separate sheets on the tray into single sheets, and a sheet supply path to guide the sheet from the separating roller to the sheet conveyance-in path 45.

Also, the stacker unit D is composed of a discharge tray that sequentially stacks and stores sheets conveyed from the conveyance outlet 52 of the sheet conveyance-out path 49 connected to the cover sheet conveyance path 48. This unit can also be equipped with a finishing unit to staple, punch holes or apply marks to sheets conveyed from the conveyance outlet 52. This finishing unit can also adopt any known and preferred mechanisms.

### Configuration for Detecting Unit-Internal Ambient Temperature

With the configuration described above, the present invention controls the temperature by detecting the temperature in the unit when controlling the temperature of the adhesive in the adhesive container 10. For that reason, the second sensor means 22c (22d) that detects the ambient temperature in the unit housing as shown in FIG. 3 is disposed in the unit housing A. As shown in the drawing, the second sensor means 22c is disposed in the adhesive-application location E, and the second sensor means 22d is disposed in the cover sheet binding position F. In other words, the second sensor means 22c and 22d that detect the ambient temperature inside the unit housing are disposed in the adhesive-application location E and the cover sheet binding position F. Their positions are shown in FIG. 3. The second sensor means 22c, 22d are composed of a thermistor or thermocouple, or the like.

Particularly, the second sensor means can, for example, be disposed separated from the range of the movement of the reciprocating adhesive container 10, or this sensor can detect the temperature when the adhesive container 10 when the adhesive container 10 has far traveled away from the position of the sensor means so that the sensor is unaffected by the adhesive temperature heated in the adhesive container 10 that reciprocates between the home position HP and the return position RP shown in FIG. 4. The second sensor means 22c shown in FIG. 4 is disposed near the return position RP and is configured to detect the ambient temperature when the adhesive container 10 is positioned at its home position HP. At least one of the second sensor means 22c, 22d disposed in the adhesive-application location E and cover sheet binding position F is wired to transmit the detected temperature to the control CPU 26 described above.

Also, the temperature control means composed of the control CPU 26 controls the heating means 20 to raise the temperature of the adhesive to a predetermined degree when the temperature detected by the second sensor means 22c, 22d is higher than a predetermined degree, and to raise the temperature of the adhesive to a predetermined degree when the temperature detected by the second sensor means 22c, 22d is lower than a predetermined degree.

This application claims priority rights from Japanese Pat. App. No. 2007-200509, which is herein incorporated by reference.

What is claimed is:

1. A bookbinding unit comprising:
a unit housing, an adhesive-application location being situated in the unit housing;
sheaf gripping means for retaining in the adhesive-application location a sheaf of sheets collated into a block;
an adhesive container disposed in the adhesive-application location, for storing hot-melt adhesive;
heating means built into the adhesive container, for melting the adhesive to a predetermined temperature;
temperature control means for controlling the heating temperature of said heating means;
application means for applying adhesive in said adhesive container to a sheaf; and
cover-sheet binding means disposed downstream of the adhesive-application location, for binding together with a cover sheet a sheaf to which adhesive has been applied; wherein
said temperature control means is furnished with
(1) a first sensor means for detecting the temperature of the adhesive in said adhesive container, and
(2) a second sensor means for detecting the ambient temperature within said unit housing, and
controls the heating temperature of said heating means according to the temperatures detected by said first and second sensor means.

2. The bookbinding unit according to claim 1, wherein said temperature control means:
raises the adhesive temperature to a preestablished degree when the temperature detected by said second sensor means is at or above a predetermined temperature; and
raises the adhesive temperature to at least a preestablished degree when the temperature detected by said second sensor means is at or below a predetermined temperature.

3. The bookbinding unit according to claim 1, wherein said second sensor means is disposed in the proximity of the cover-sheet binding position, to detect the ambient temperature of sheaves to which covers are bound.

4. The bookbinding unit according to claim 2, wherein said second sensor means is disposed in the proximity of the cover-sheet binding position, to detect the ambient temperature of sheaves to which covers are bound.

5. The bookbinding unit according to claim 1, wherein said second sensor means is disposed in the proximity of the adhesive-application location, to detect the ambient temperature of sheaves to which the adhesive is applied.

6. The bookbinding unit according to claim 2, wherein said second sensor means is disposed in the proximity of the adhesive-application location, to detect the ambient temperature of sheaves to which the adhesive is applied.

7. The bookbinding unit according to claim 5, wherein:
said adhesive container is disposed to allow it to shift reciprocatingly along an edge-face of a sheaf retained in the adhesive-application location; and
said second sensor means either is disposed outside of the range over which said adhesive container shifts, or is disposed so as to detect the unit-internal temperature when the adhesive container is positioned remotely.

8. The bookbinding unit according to claim 6, wherein:
said adhesive container is disposed to allow it to shift reciprocatingly along an edge-face of a sheaf retained in the adhesive-application location; and
said second sensor means either is disposed outside of the range over which said adhesive container shifts, or is disposed so as to detect the unit-internal temperature when the adhesive container is positioned remotely.

9. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 1.

10. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 2.

11. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 3.

12. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 4.

13. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 5.

14. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 6.

15. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 7.

16. An image-forming system comprising:
an image forming unit having imaging means for sequentially forming images onto sheets; and
a bookbinding apparatus for collating into a book-block sheets from said image-forming unit and applying adhesive to the book-block, and thereafter binding the block together with a cover sheet; wherein
the bookbinding apparatus has a compiling means for collating into book-blocks sheets conveyed from said imaging means, and is furnished with the constitution set forth in claim 8.
